(19) United States
(12) Patent Application Publication
(10) Pub. No.: US 2022/0349774 A1
(43) Pub. Date: Nov. 3, 2022

(54) SYSTEM AND METHOD FOR DETERMINING A FASTENER PREDICTIVE LIFE

(71) Applicant: Baker Hughes Oilfield Operations LLC, Houston, TX (US)

(72) Inventors: Javier FRANCO, Houston, TX (US); Jeffery FISHER, Houston, TX (US); Connor COOK, Houston, TX (US); Kevin SWEENEY, Houston, TX (US)

(73) Assignee: Baker Hughes Oilfield Operations LLC, Houston, TX (US)

(21) Appl. No.: 17/243,163

(22) Filed: Apr. 28, 2021

(51) Int. Cl. G01M 3/28

(52) U.S. Cl. CPC G01M 3/2876

(57) ABSTRACT

A method for determining a predictive life of a pressure containing component includes determining, from sensor data, one or more cycles. The method also includes generating one or more additional cycles. The method further includes determining a component feature is below a threshold. The method further includes generating one or more supplementary cycles. The method also includes determining, from the one or more cycles, the one or more additional cycles, and the one or more supplementary cycles, the component feature. The method includes determining the component feature exceeds the threshold. The method further includes determining, based at least in part on the one or more supplementary cycles, a predictive life for the pressure containing component.

### BACKGROUND

### 1. Field of the Disclosure

The present disclosure relates to pressure containing components. Specifically, the present disclosure relates to systems and methods for determining a predictive life for fasteners of those pressure containing components under a variety of load conditions and setting a maintenance schedule responsive to the predictive life.

### 2. Description of Related Art

A variety of fasteners may be used in industrial operations, such as bolts to connect various components together. During operations, fasteners may be cycled where a fastener is in a first condition, such as a set condition, then undergoes stretching or strain due to a load, and then is returned to the first condition. Over time, this may cause fatigue on the materials forming the fasteners, which may lead to failures. Additionally, environmental conditions may further affect load conditions, such as high temperature or high pressure situations. To account for wear or fatigue on the fasteners, components often undergo preventative maintenance operations. However, these operations may be expensive, time consuming, and premature if the loading on the fastener does not necessitate the operation.

### SUMMARY

Applicants recognized the problems noted above herein and conceived and developed embodiments of systems and methods, according to the present disclosure, for predictive life determinations.

In an embodiment, a system for determining a predictive life of a pressure containing component includes a blowout preventer (BOP) having one or more cavities with respective associated components, wherein a cavity of the one or more cavities are exposed to a pressure responsive to activation of at least a portion of the BOP. The system also includes a sensor associated with the BOP. The system further includes a control system associated with the BOP, the control system receiving sensor information corresponding to pressure within the one or more cavities, the control system including a processor and a memory. The memory stores instructions that, when executed by the processor, cause the processor to determine, from the sensor information, one or more cycles for the BOP. The instructions also cause the processor to simulate additional cycles for the BOP, generate a cycle set, including at least the one or more cycles and the additional cycles, process, via a fracture mechanics model, the cycle set, determine a component feature for at least one component of the respective associated components, based at least in part on the processing, and determine, based at least in part on the component feature, a predictive life for the at least one component.

In another embodiment, a method for determining a predictive life of a pressure containing component includes determining, from sensor data, one or more cycles. The method also includes generating, based at least in part the one or more cycles, one or more additional cycles. The method further includes determining, from the one or more cycles and the one or more additional cycles, a component feature, the component feature corresponding to a failure mechanic of the pressure containing component. The method also includes determining the component feature is below a threshold. The method further includes generating one or more supplementary cycles. The method also includes determining, from the one or more cycles, the one or more additional cycles, and the one or more supplementary cycles, the component feature. The method includes determining the component feature exceeds the threshold. The method further includes determining, based at least in part on the one or more supplementary cycles, a predictive life for the pressure containing component.

In an embodiment, a system for determining a predictive life of a pressure containing component includes a blowout preventer (BOP) having one or more cavities with respective associated components, wherein a cavity of the one or more cavities are exposed to a pressure responsive to activation of at least a portion of the BOP. The system also includes a sensor associated with the BOP. The system further includes a control system configured to determine, based at least in part on sensor information corresponding to one or more cycles for the BOP, a predictive life for at least one of the respective associated components, the predictive life being based, at least in part, on a fracture mechanics model processing the sensor information and historical information to determine a difference between a current state of the at least one respective associated component and a failure state.

In an embodiment, a system for determining a predictive life of a pressure containing component includes a blowout preventer (BOP) having one or more cavities with respective associated components, wherein a cavity of the one or more cavities are exposed to a pressure responsive to activation of at least a portion of the BOP. The system includes a sensor associated with the BOP. The system also includes a control system associated with the BOP, the control system receiving sensor information corresponding to pressure within the one or more cavities. The control system includes a processor and a memory. The memory stores instructions that, when executed by the processor, cause the processor to determine, from the sensor information, a cycle set including at least one or more cycles for the BOP. The memory stores instructions that, when executed by the processor, cause the processor to process, via a fracture mechanics model, the cycle set. The memory stores instructions that, when executed by the processor, cause the processor to determine a component feature for at least one component of the respective associated components, based at least in part on the processing. The memory stores instructions that, when executed by the processor, cause the processor to determine, based at least in part on the component feature, a predictive life for the at least one component.

In an embodiment, a method for determining a predictive life of a pressure containing component includes determining, from sensor data, one or more cycles. The method also includes determining, from at least the one or more cycles, a component feature, the component feature corresponding to a failure mechanic of the pressure containing component. The method further includes determining the component feature is below a threshold. The method also includes generating one or more supplementary cycles. The method includes determining, from the one or more cycles and the one or more supplementary cycles, the component feature. The method also includes determining the component feature exceeds the threshold. The method further includes determining, based at least in part on the one or more supplementary cycles, a predictive life for the pressure containing component.

### BRIEF DESCRIPTION OF DRAWINGS

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

FIG. 1 is a schematic side view of an embodiment of an offshore drilling operation, in accordance with embodiments of the present disclosure;

FIG. 2 is a schematic diagram of an embodiment of a blowout preventer (BOP) set, in accordance with embodiments of the present disclosure;

FIGS. 3A and 3B are graphical representations of pressure cycles, in accordance with embodiments of the present disclosure;

FIG. 4 is a schematic diagram of an embodiment of an evaluation environment, in accordance with embodiments of the present disclosure;

FIG. 5 is a flow chart of an embodiment of a method for determining a predictive life, in accordance with embodiments of the present disclosure; and

FIG. 6 is a flow chart of an embodiment of a method for determining a predictive life, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions.

Embodiments of the present disclosure are directed toward systems and methods for predictive life determination for fasteners, such as bolts. In at least one embodiment, systems and methods may be directed predictive life determination for one or more wellbore components or pressure containing components, which may include features within or external to the wellbore. In at least one embodiment, wellbore components and/or pressure containing components may refer to BOPs, BOP flange bolting, BOP side outlet bolting, wellhead connector bolting, and the like. In at least one embodiment, one or more wellbore components or pressure containing components may refer to any component exposed to or associated with the control or containment of wellbore pressure or drilling fluids. In various embodiments, systems and methods are utilized to determine a number of cycles and/or magnitudes of those cycles that certain fasteners are subjected to and determine a predictive life using, at least in part, a fracture mechanic model. In at least one embodiment, various fracture mechanics methods define a crack growth calculation equation, which uses inputs regarding bolt geometry, bolt material, crack/defect initial condition assumptions, and bolt stress due to applied load/pressure. Embodiments of the present disclosure provide a model to output bolt stress as a function of differential pressure (e.g., max pressure—start pressure). This model provides additional advantages of accounting for system loading and design, rather than calculating only for worst case loading. As a result, a more accurate model may be provided that utilizes more information regarding the actual loading seen by the system. In one or more embodiments, fracture mechanics may be particularly selected for certain operating or expected operating conditions of the fasteners, such as high pressure and high temperature models. In various embodiments, pressure cycles may be determined using one or more sensors operating with equipment, such as, but not limited to, blowout preventers (BOPs). One or more sensors may provide indications of pressure cycles, which may be utilized to extract information, such as start/stop times, maximum pressures, and the like. It should be appreciated that one or more metrics or thresholds may be utilized to determine what types of data constitute a cycle. For example, a threshold pressure differential may be utilized to determine whether a cycle has occurred. Furthermore, in one or more embodiments, a duration may also be utilized to evaluate cycles. In one or more embodiments, additional data may be added, such as safety factors or appended data to account for operating conditions, among other such options. This information may then be utilized with one or more fracture mechanic models, which may be predetermined using one or more computational methods or may be extrapolated from historical data, or a combination thereof. The fracture mechanic models may model cracks or other deformities within the fastener, which may be evaluated against a threshold (e.g., crack threshold, deformity threshold, etc.) to determine whether further processing is desirable. For example, if the model is less than a threshold, additional simulated cycles may be added to the model until the threshold is exceeded. Thereafter, historical data may be used to predict a time that these additional cycles will be reached. In this manner, preventative maintenance may be scheduled based on cycle information for the fasteners, rather than a set period of time. Accordingly, preventative maintenance cycles may be reduced, which may reduce costs, or may be increased to provide improved safety to operations.

In at least one embodiment, data may be acquired from one or more operating units, such as the BOPs noted above, in real time or near-real time (e.g., without significant delay). This information may be combined with one or more fracture mechanics models, which may be computed and/or developed using historical information, to estimate a remaining useful life and/or predictive life for fasteners or other components associated with the operating units. Traditionally, fastener maintenance is defined on a time based interval by assuming that one or more components is used and/or tested in the field to the rated pressure. As a result, operators assume or estimate how many cycles are done at the rated pressure during a given period of time and then determine when maintenance will be performed. By way of example only, the time period may be approximately two years for fasteners associated with BOPs. Systems and methods of the present disclosure evaluate actual history and exposure of the components, and their associated fasteners, rather than assuming a rated pressure. As a result, fracture mechanics models may utilize improved input data to more accurately predict estimated life. Accordingly, systems and methods may provide an improved maintenance solution that may enable improved operational efficiency, for example, by extending time periods between preventative maintenance, thereby saving operators money without increasing risks of component failure.

In at least one embodiment, sensor data is used to distinguish one or more cycles for life determination. Moreover, sensor data may also capture the magnitude of each cycle (e.g., pressure). In at least one embodiment, magnitude may be evaluated relative to a steady state, as opposed to an absolute magnitude. Component life may be dependent on cycle quantity and magnitude. The unique magnitude of each cycle is captured and fed into an evaluation system. In at least one embodiment, supplementary cycle magnitude (e.g., predicted cycles) are based in part on the historical cycle magnitudes for the given system. Accordingly, a predictive life may be determined by evaluating, at least in part, both a number of cycles and a magnitude of those cycles for various fasteners.

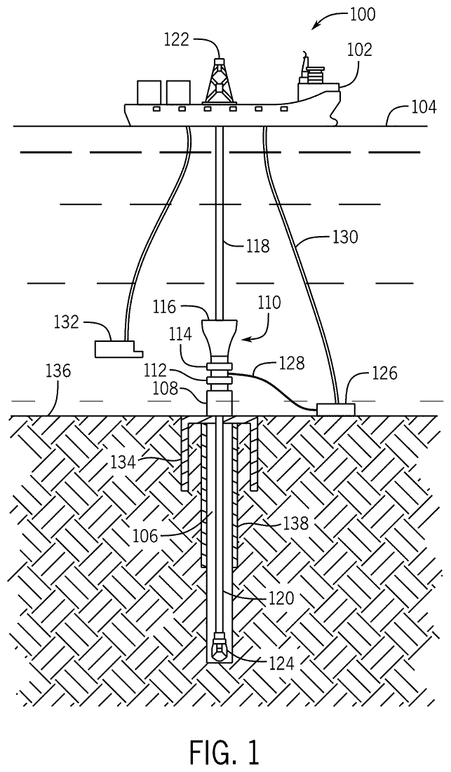

FIG. 1 is a side schematic view of an embodiment of subsea drilling operation 100. The drilling operation includes a vessel 102 floating on a sea surface 104 substantially above a wellbore 106. A wellbore housing 108 sits at the top of the wellbore 106 and is connected to a blowout preventer (BOP) assembly 110, which may include shear rams 112, sealing rams 114, and/or an annular ram 116. One purpose of the BOP assembly 110 is to help control pressure in the wellbore 106. The BOP assembly 110 is connected to the vessel 102 by a riser 118. During drilling operations, a drill string 120 passes from a rig 122 on the vessel 102, through the riser 118, through the BOP assembly 110, through the wellhead housing 108, and into the wellbore 106. It should be appreciated that reference to the vessel 102 is for illustrative purposes only and that the vessel may be replaced with a floating platform or other structure. The lower end of the drill string 120 is attached to a drill bit 124 that extends the wellbore 106 as the drill string 120 turns. Additional features shown in FIG. 1 include a mud pump 126 with mud lines 128 connecting the mud pump 126 to the BOP assembly 110, and a mud return line 130 connecting the mud pump 126 to the vessel 102. A remotely operated vehicle (ROV) 132 can be used to make adjustments to, repair, or replace equipment as necessary. Although a BOP assembly 110 is shown in the figures, the wellhead housing 104 could be attached to other well equipment as well, including, for example, a tree, a spool, a manifold, or another valve or completion assembly.

One efficient way to start drilling a wellbore 106 is through use of a suction pile 134. Such a procedure is accomplished by attaching the wellhead housing 108 to the top of the suction pile 134 and lowering the suction pile 134 to a sea floor 136. As interior chambers in the suction pile 134 are evacuated, the suction pile 134 is driven into the sea floor 136, as shown in FIG. 1, until the suction pile 134 is substantially submerged in the sea floor 136 and the wellhead housing 108 is positioned at the sea floor 136 so that further drilling can commence. As the wellbore 106 is drilled, the walls of the wellbore are reinforced with concrete casings 138 that provide stability to the wellbore 106 and help to control pressure from the formation.

In various embodiments, the BOP assembly 110 may include various fasteners, for example between different cavities associated with the various rams 112, 114, 116. These fasteners may correspond to bonnet bolts, among other components, where a pressure within the cavity may be determined as a cycle, for example when the pressure exceeds a threshold and/or a period of time of pressure exposure, among other potential qualifiers. One or more embodiments may include sensors that determine pressure within the cavity and then record and/or transmit the information to a controller for analysis. The controller may include a memory and processor for executing software instructions to analyze the information and to determine whether or not a cycle has occurred. Furthermore, this controller may also or alternatively be used to transmit data to a remote server or computing unit to perform various analysis operations. This information may then be utilized with one or more fracture mechanics models to estimate a useful life for the fasteners, which may enable an increased time between maintenance operations, thereby reducing costs. It should be appreciated that existing methods apply maintenance operations on a predetermined time frame without considering actual loading of the fasteners, but rather, by estimating a load. Systems and methods of the present disclosure improve on this process by determining an actual loading for the fasteners. Moreover, systems and methods may apply additional safety factors or the like to provide further simulations of the loading. Accordingly, in various embodiments, fracture mechanics models may process both acquired data and simulated data, where the simulated data may be generated, at least in part, by evaluating historical data. It should be appreciated that a location of the cycle may be also considered, for example, when a lower cavity is pressured then a higher number of cycles may be experienced by the bonnets. Therefore, systems and methods may further simulate cycles for different cavities based at least in part on pressure conditions of adjacent or surrounding cavities.

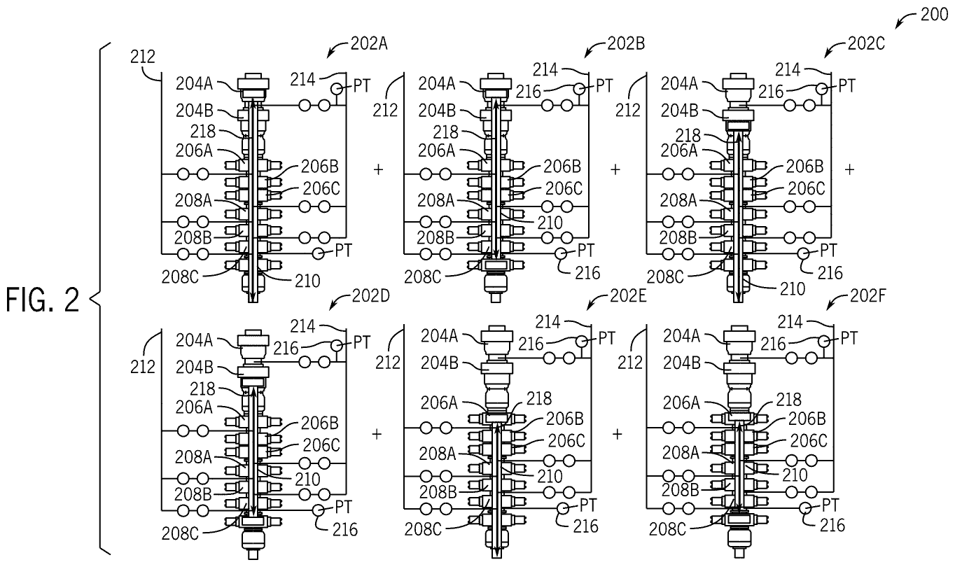

FIG. 2 is a schematic diagram of a BOP set 200 including a plurality of BOPs 202A-202N. It should be appreciated that the inclusion of 6 BOPs 202 is for illustrative purposes only and that any number of BOPs 202 may be utilized with embodiments of the present disclosure. In this example, each BOP 202 of the set 200 includes annulars 204A, 204B (e.g., an upper annular and a lower annular), shear rams 206A-206C (e.g., upper blind shear rams, casing shear rams, lower blind shear rams), pipe rams 208A-208C (e.g., upper pipe rams, middle pipe rams, lower pipe rams), and a test ram 210 (e.g., subsea stack test ram). It should be appreciated that other rams may also be included, such as variable bore rams and the like. Accordingly, the configurations shown in FIG. 2 are for illustrative purposes and are not intended to limit the scope of the present disclosure.

As shown, the illustrated BOPs 202 include a kill line 212 and a choke line 214 extending to different regions or cavities associated with the various rams 204, 206, 208, 210. In various embodiments, the kill line 212 is coupled to high pressure rig pumps and may transport fluid into the BOP 202, for example to control the well. The choke line 214 is coupled to a choke manifold (not pictured) to facilitate flow after the well is shut in via the BOP 202. As will be appreciated, the different positions of the lines 212, 214 enable operations at different stages when different rams 204, 206, 208, 210 are utilized.

Further illustrated in FIG. 2 are sensors 216, which in this example are pressure sensors. The pressure sensors may be transducers that record a pressure reading within the choke line 214, within the BOP 202, or within the kill line 212. It should be appreciated the sensors 216 may be coupled to one or more controllers that include circuitry to receive and transmit signals, for example to receive signals from the sensors 216 and transmits the signals for analysis. Additionally, the one or more controllers may also record and/or store the data for later analysis. In various embodiments, the sensors 216 may transmit information in near or near-real time as a continuous stream. However, in one or more embodiments, the sensors 216 may transmit information at different time intervals or responsive to a request to provide data. In this example, the sensors are positioned between the pipe rams 208 and the test ram 210 and also on the choke line 214, but as noted above, may be positioned in various other locations. In at least one embodiment, a lower sensor 216 associated with the space between the test ram 210 and the pipe rams 208 may be desirable to enable detection of wellbore pressure during operation of any of the various rams 204, 206, 208, 210, made possible by the operating characteristic that wellbore pressure will be sealed below each annular or ram except for the test ram 210, which seals pressure above the ram.

The example BOPs 202 in the set 200 illustrate activation in a variety of different configurations, where a fluid level 218 is shown within the BOP 200. Starting with the BOP 202A, the annular 204A is shown in an activated position such that the fluid level 218 stops at the annular 204A. However, the BOP 202B illustrates both the annular 204A and the test ram 210 in activated positions, thereby isolating the fluid level 218 between the annular 204A and the test ram 210.

Turning to the BOP 202C, the annular 204B is shown in activated position such that the fluid level 218 stops at the annular 204B. However, the BOP 202D illustrates both the annular 204B and the test ram 210 in activated positions, thereby isolating the fluid level 218 between the annular 204B and the test ram 210. Continuing with the BOP 202E, the shear ram 206A is shown in an activated position such that the fluid level 218 stops at the shear ram 206A. However, the BOP 202F illustrates both the shear ram 206A and the test ram 210 in activated positions, thereby isolating the fluid level 218 between the shear ram 206A and the test ram 210. It should be appreciated that the lower the cavity in the stack, the higher number of cycles experienced by the bonnet. Accordingly, in various embodiments, it should be appreciated that preventative maintenance may be scheduled for the BOP 202 as a whole, and not for individual portions, and therefore, the worst case cavity and/or fastener may control maintenance operations.

In at least one embodiment, pressure cycles may be counted by summing all instances where there was pressure in the cavity based on the different configurations of annulars and rams. Accordingly, each of the configurations shown in FIG. 2 would correspond to a pressure cycle within the shear ram 206A, even though only BOPs 202E, 202F have the shear ram 206A in the activated condition.

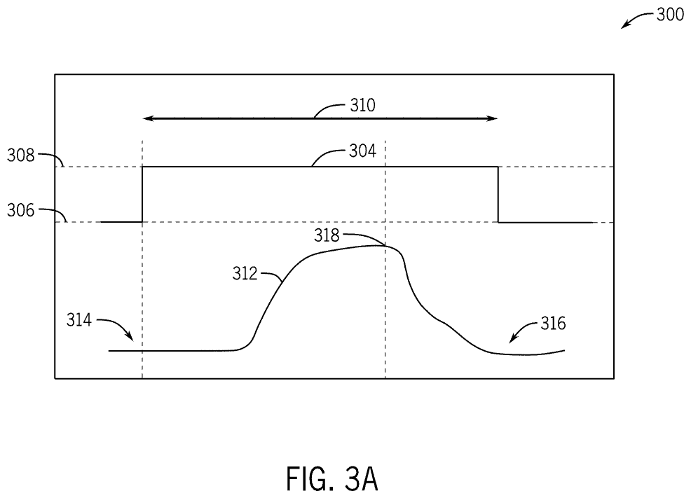

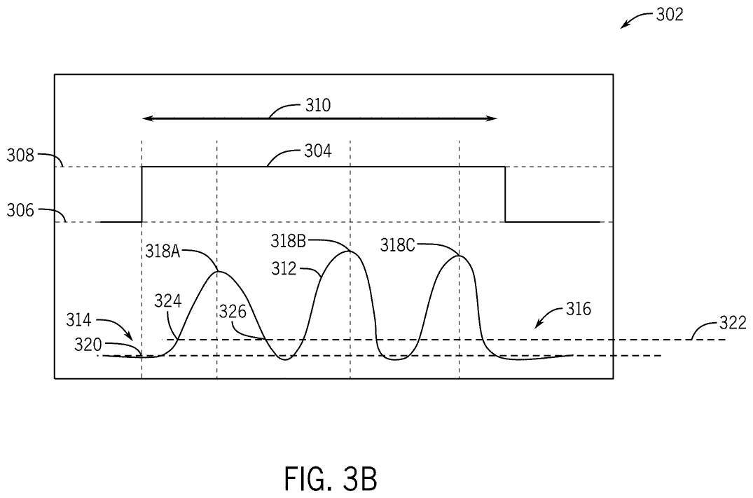

FIGS. 3A and 3B are schematic representations 300, 302 illustrating pressure cycles. In these examples, FIG. 3A illustrates an assumed pressure cycle with a clear transition between open and closed positions. In this example, a status indicator 304 is illustrated at an open position 306 at a first time with an abrupt transition to a closed position 308 and then, after a time period 310, transitioning back to the open position 306. As this cycle is happening, pressure experienced by the fasteners is illustrated by a pressure indicator 312. In this example, a cycle start 314 is shown that aligns approximately with the transition to the closed position 308, extends for the time period 310, and then stops at a cycle stop 316. In one or more embodiments, a pressure at the start is recorded, as indicated by the dashed vertical line. During this time, the pressure indicator 312 increases to a maximum point 318. It should be appreciated that the maximum point may not be the absolute maximum, but may be within a threshold amount of a maximum. Then, as shown, the pressure decreases, thereby providing a substantially bell-shaped or wave-shaped indication of pressure within the cavity. As will be described below, the maximum pressure may be useful information to acquire for later analysis.

However, it should be appreciated that the representation 300 may not be present in an operational well. As a result, the representation 302 illustrates a variable pressure cycle, where the position of the valve may be maintained, the pressure experienced by the valve may spike or otherwise change over time throughout the cycle. Similar to the representation 300, the status indicator 304 is illustrated at the open position 306 at a first time with an abrupt transition to the closed position 308 and then, after the time period 310, transitioning back to the open position 306. As this opening and closing is happening, pressure experienced by the fasteners is illustrated by the pressure indicator 312. In this example, the pressure indicator includes three different maximum point 318A-318C throughout the singular cycle. Accordingly, it may not be accurate to only use a singular maximum point when three separate maximum were utilized. As will be described below, the maximum values may be compared to determine which one to utilize and/or three different cycles may be counted for this particular situation. For example, in various embodiments, a peak may be compared to a start pressure, and as long as a difference between the peak and the start pressure exceeds a threshold, it may be determined as a cycle. Furthermore, the cycles may be bracketed such that a decrease below a threshold is utilized to reset or restart evaluation of a cycle.

By way of example only, three peaks are illustrated in FIG. 3B. A start value 320 is illustrated as a horizontal line and a reset value 322 is illustrated as another line, which may be equal to or within a threshold of the start value 320. Accordingly, as the reset value 322 is crossed at a first point 324 a potential cycle is tracked. As the cycle continues, the maximum 318A is determined. The cycle is continuously tracked until a second point 326, where the pressure indicator 312 cross below the reset value 322. This process may be repeated throughout the time period 310 to determine a number of cycles and their respective maximum values.

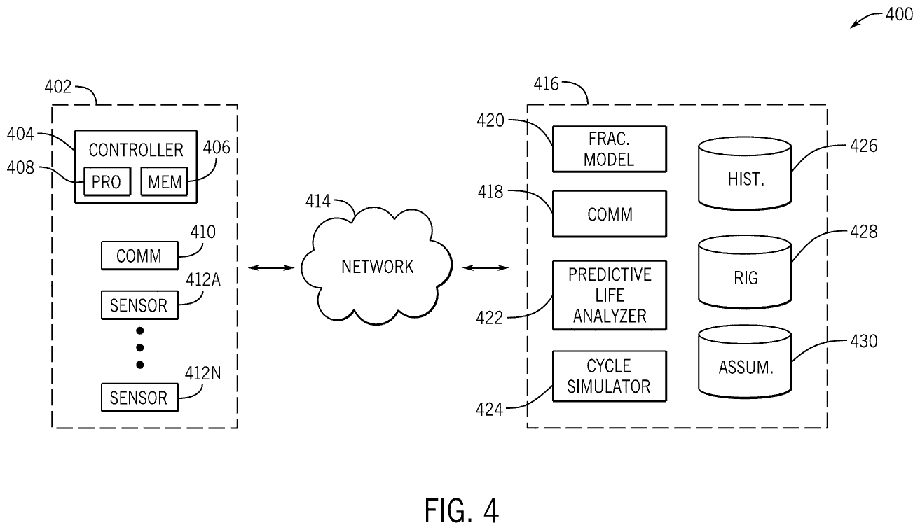

FIG. 4 is a schematic diagram of an embodiment of an environment 400 for determining a predictive life for one or more components, such as a fastener. In this example, a rig environment 402 includes a controller 404 having a memory 406 and a processor 408. It should be appreciated that there may be more controllers that utilize more memories and processors. The processor 408 may execute instructions stored on the memory 406. In this example, a communication module 410 is further illustrated for transmitting information from the rig environment 402. By way of example, the communication module 410 may include one or more wired or wireless protocols for transmitting information. In at least one embodiment, the communication module 408 transmits information from one or more sensors 412A-412N, which may be associated with BOPs, as described above. By way of example, the communication module 410 may receive information from the sensors 412A-412N and then transmit the information over a network 414 to an analysis environment 416. It should be appreciated that the illustration of the analysis environment 416 being separate from the rig environment 402 is by way of example and is not intended to be limiting, as the analysis may also be performed directly on the rig, among other options.

It should be appreciated that the analysis environment 416 may be associated with one or more processors executing instructions stored on memory. Furthermore, the analysis module 416 may be associated with a distributed computing environment. In this example, the analysis environment 416 includes a communication module 418 for receiving information over the network 414, such as via one or more wired or wireless data communication protocols. The illustrated embodiment further includes a fracture model module 420 for generating and/or storing one or more fracture mechanics models. The fracture mechanics models may be developed using computational methods provided for an industry and/or developed by analyzing past data. In at least one embodiment, different models are developed and particularly selected for different operating conditions. For example, a fracture mechanics model may differ between an offshore application and a surface application. In at least one embodiment, various fracture mechanics methods define a crack growth calculation equation, which uses a variety of different inputs (e.g., bolt geometry, bolt material, crack/defect initial condition assumptions, and bolt stress due to applied load/pressure). However, typical models may only evaluate worst case loading scenarios, while disregarding actual loading seen by the system. In various embodiments, the fracture mechanics module 420 may include a definition of bolt stress as a function of differential pressure based on design conditions and loading of the system. In other words, the fracture mechanics module may include a relation for bolt stress as a function of wellbore pressure which enables the output/result of actual crack growth for each cycle, based on cycle magnitude.

In at least one embodiment, a predictive life analyzer 422 determine a predictive life for one or more components, such as a fastener, associated with the sensor data received from the rig. The predictive life analyzer may incorporate information from the fracture model module 420, a cycle simulator 424, and/or one or more databases 426, 428, 430. In this example, the cycle simulator 424 may add additional cycles on top of those evident from the sensor data. By way of example only, additional cycles may be added to account additional potential cycles or operations due to an auxiliary test stack system (ASTS), remotely operated vehicle (ROV), and/or an autoshear and deadman (ASDM) system not captured by the data. In various embodiments, additional cycles may be a set number, such as an additional 20% of historical cycles, or any other reasonable value. Furthermore, the cycle simulator 424 may also attribute a pressure value to the cycles, for example, a maximum pressure differential in scenarios to provide a cushion or safety factor. Furthermore, in various embodiments, a historical average may be used to add cycles iteratively for the predictive life analyzer.

Information may be acquired and utilized by components of the analysis environment 416 from the one or more databases 426, 428, 430. In this example, the database 426 is a historical data that includes information for previous rigs and components, such as those operating under similar conditions as existing rigs. By way of example, the historical data may include fracture mechanics models, maintenance schedules, and the like along with information that may be correlated to existing rig information, such as operating conditions. The database 428 is a rig database that tracks information for a particular rig over its life. As a result, historical averages for the rig may be identified and utilized by the cycle simulator 424. In this example, the database 430 is an assumption database that includes information and assumptions, such as factors to apply to various portions of the models. For example, the 20% addition for historical cycles may be stored and adjusted through the assumption database 430. It should be appreciated that this information may be adjusted and tuned for different rigs operating under different environments.

In operation, data is acquired by the sensors 412A-412N and transmitted to the analysis environment 416. It should be appreciated that data transmission may occur in real or near-real time (e.g., without significant delay). This data is analyzed, for example via the predictive life analyzer 422, to identify cycles (e.g., a number of cycles, pressures within the cycles, etc.). The predictive life analyzer 422 may then utilize information from one or more fracture models, the cycle simulator 422, and/or one or more databases 426, 428, 430 to determine whether a threshold is reached with respect to an existing life. The predictive life analyzer 422 may also simulate scenarios with additional cycles to determine a useful life and then determine a maintenance schedule for the one or more components associated with the data.

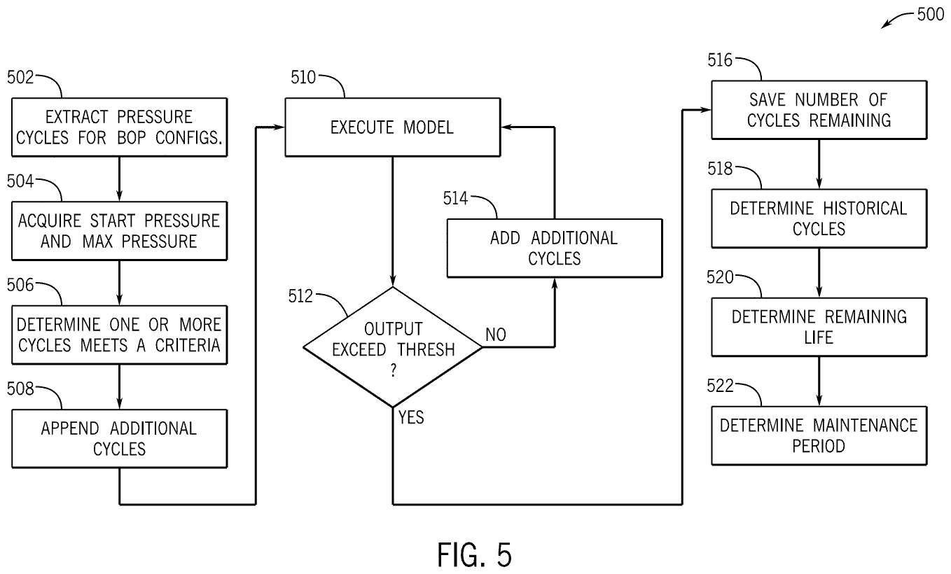

FIG. 5 is a process flow diagram of an embodiment of a process 500 for calculating a predictive life and setting a maintenance recommendation. It should be appreciated that this method, and all processes and/or methods described herein, may include more or fewer steps. Additionally, the steps may be performed in any order, or in parallel, unless otherwise specifically stated. In this example, pressure cycles are extracted for various BOP configurations 502. It should be appreciated that these cycles may be from historical information or determined through real or near-real time data. The cycle information is used to extract a starting pressure and one or more maximum pressures 504. For example, a starting pressure may be determined at a time when the BOP switches to a closed position and then a maximum pressure over a period of time may be determined. The cycle information may be utilized then to determine whether the cycle satisfies a cycle criteria 506. By way of example, the cycle criteria may evaluate a difference between the start pressure and the maximum pressure to determine whether the difference exceeds a threshold, such as 100 psi. It should be appreciated that 100 psi is provided as an example only, and that other thresholds may be used.

In various embodiments, historical cycle information is utilized to append additional cycles to the known and/or acquired cycle information to account for non-counted or non-measured operations 508. As an example, a set number of cycles, such as 20%, may be added to account for ASTS, ROV, and ASDM. Moreover, a pressure may be set for these cycles, such as 15,000 psi or a set pressure, among other options. It should be appreciated that, in various embodiments, additional cycles may not be included. For example, in one or more embodiments, additional cycles may correspond to an added safety factor or margin of error to account for cycles which may have occurred during non-normal operations conditions where sensor data did not capture the cycles. However, in various embodiments, sensor data may capture all or substantially all of the cycles, and as a result, additional cycles or simulated cycles may not be utilized. The acquired data may be added to the appended additional cycles and used as an input into a fracture mechanics model 510. However, in other embodiments, only the acquired data is utilized. The model output may be analyzed against a threshold for one or more features, such as a crack 512. If the crack depth does not exceed a threshold, additional cycles may be added 514 for further processing with the model. By way of example, historical data may be analyzed to identify and select additional cycles to add. If the crack depth does exceed the threshold, the number of added cycles may be saved 516. For example, the number of existing cycles added to exceed the threshold may be saved and interpreted as a number of remaining cycles. This saved number of added cycles is then utilized, for example by determining a number of cycles from historical data 518, to determine an estimated remaining life 520. It should be appreciated that the remaining life may be estimated in remaining days, for example, by determining a number of average cycles per day compared to the number of cycles remaining. The estimated remaining life may then be used to determine a maintenance period 522. This maintenance period may then be applied to an existing schedule to update or adjust a scheduled maintenance operation. In this manner, data extracted from well site operations may be combined with historical information and simulated well site data to improve and/or adjust maintenance operations.

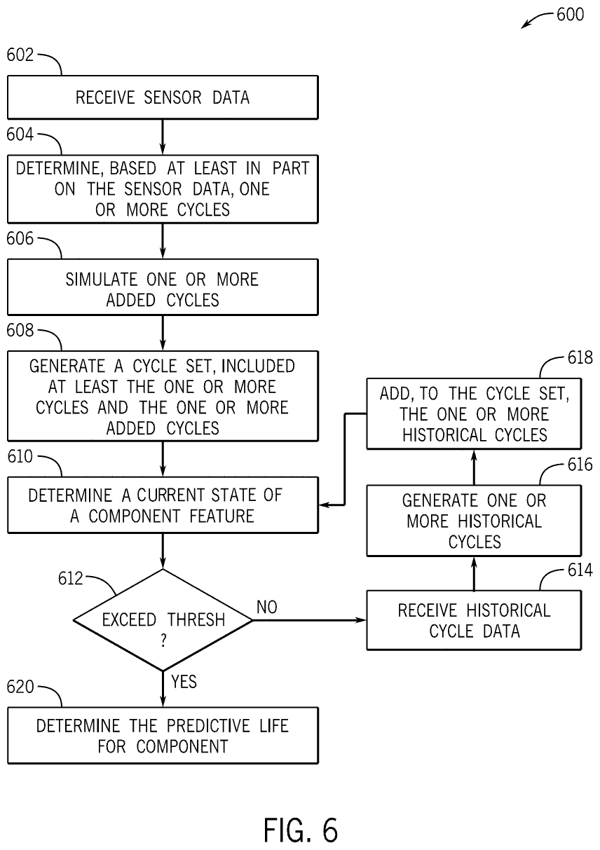

FIG. 6 is a flow chart of an embodiment of a method 600 for determining a predictive life for a component. In this example, sensor data is received 602. In one or more embodiments, the sensor data is received from a BOP and is associated with a rig. However, it should be appreciated that other sensor data may also be utilized. The sensor data may include pressure data associated with pressure within the BOP, a status indicator for a BOP's activation status, or the like. Based at least in part on the sensor data, one or more cycles are determined 604. A cycle may be determined based on whether a difference between maximum pressure within a time period and a starting pressure exceeds a threshold. As noted above, there may be numerous cycles during a single opening/closing period of the BOP. These cycles may be recorded with their maximum values. One or more added cycles may then be simulated 606. The added cycles may be simulated based on expected operations that may not be recorded by the sensors. However, as noted above, in various embodiments additional simulated cycles may not be utilized.

In at least one embodiment, a cycle set is generated that includes the cycles extracted from the sensor data and the simulated added cycles 608. But, in certain embodiments, simulated added cycles are omitted. From this cycle set, a current state of a component feature may be determined 610. In one or more embodiments, the component feature may be associated with a crack or flaw within a bonnet bolt. In fracture mechanics, it may be assumed that a crack or flaw is present (e.g., an assumed initial condition), and cycles and cycle magnitudes are used to calculate the crack growth. A maximum allowable crack size (e.g., a threshold) may be determined using fracture mechanics analysis as well. The fracture mechanic model may determine a current state of the component, which may be compared to a threshold 612. If the current state does not exceed the threshold, then historical cycle data may be acquired 614. This data may then be utilized to simulate additional historical cycles 616 and add the historical cycles to the cycle set 618. However, if the current state does exceed the threshold, then a predictive life for the component is determined 620. In this manner, preventative operations or maintenance operations may be analyzed and updated based on actual use of the components, as opposed to time-based estimates.

The foregoing disclosure and description of the disclosed embodiments is illustrative and explanatory of the embodiments of the invention. Various changes in the details of the illustrated embodiments can be made within the scope of the appended claims without departing from the true spirit of the disclosure. The embodiments of the present disclosure should only be limited by the following claims and their legal equivalents.

1. A system for determining a predictive life of a pressure containing component, comprising:
a blowout preventer (BOP) having one or more cavities with respective associated components, wherein a cavity of the one or more cavities are exposed to a pressure responsive to activation of at least a portion of the BOP;
a sensor associated with the BOP;
a control system associated with the BOP, the control system receiving sensor information corresponding to pressure within the one or more cavities, the control system including a processor and a memory, the memory storing instructions that, when executed by the processor, cause the processor to:
determine, from the sensor information, a cycle set including at least one or more cycles for the BOP;
process, via a fracture mechanics model, the cycle set;
determine a component feature for at least one component of the respective associated components, based at least in part on the processing; and
determine, based at least in part on the component feature, a predictive life for the at least one component.

2. The system of claim 1, wherein the sensor is positioned proximate a lowest cavity of the one or more cavities.

3. The system of claim 1, wherein the memory stores instructions that, when executed by the processor, further cause the processor to:
determine a starting pressure for a first cycle;
determine a maximum pressure for the first cycle;
determine a difference between the maximum pressure and the starting pressure exceeds a threshold.

4. The system of claim 1, further comprising:
a communication system coupled to the sensor, the communication system transmitting the sensor information in real or near-real time.

5. The system of claim 1, wherein the memory stores instructions that, when executed by the processor, further cause the processor to:
determine a number of remaining cycles;
determine, based at least in part on historical data, a number of cycles over a period of time; and
determine, based at least in part on the predictive life, a maintenance period.

6. The system of claim 1, wherein the memory stores instructions that, when executed by the processor, further cause the processor to:
simulate additional cycles for the BOP; and
incorporate the additional cycles into the cycle set.

7. The system of claim 1, wherein the memory stores instructions that, when executed by the processor, further cause the processor to:
determine a starting pressure for a first cycle;
determine a maximum pressure for the first cycle;
determine a difference between the maximum pressure and the starting pressure is below a threshold; and
discard the first cycle.

8. A method for determining a predictive life of a pressure containing component, comprising:
determining, from sensor data, one or more cycles;
determining, from at least the one or more cycles, a component feature, the component feature corresponding to a failure mechanic of the pressure containing component;
determining the component feature is below a threshold;
generating one or more supplementary cycles;
determining, from the one or more cycles and the one or more supplementary cycles, the component feature;
determining the component feature exceeds the threshold; and
determining, based at least in part on the one or more supplementary cycles, a predictive life for the pressure containing component.

9. The method of claim 8, further comprising:
generating, based at least in part on the one or more cycles, one or more additional cycles, wherein the one or more additional cycles are based, at least in part, on a quantity of the one or more cycles.

10. The method of claim 8, further comprising:
determining, based at least in part on historical data, a number of cycles over a period of time; and
determining, based at least in part on the supplementary cycles, a remaining life for the pressure containing component.

11. The method of claim 8, further comprising:
responsive to the predictive life, updating a maintenance period for the pressure containing component.

12. The method of claim 8, wherein the sensor data is streaming data acquired from a blowout preventer (BOP).

13. The method of claim 8, further comprising:
selecting, based at least in part on one or more properties of the pressure containing component, a fracture mechanic model.

14. The method of claim 8, further comprising:
determining a starting pressure for a first cycle;
determining a maximum pressure for the first cycle;
determining a difference between the maximum pressure and the starting pressure exceeds a cycle threshold.

15. The method of claim 8, further comprising:
determining a starting pressure for a first cycle;
determining a maximum pressure for the first cycle;
determining a difference between the maximum pressure and the starting pressure is below a cycle threshold; and
discarding the first cycle.

16. The method of claim 8, wherein the one or more supplementary cycles are based, at least in part, on historical data for the pressure containing component.

17. The method of claim 8, wherein a pressure corresponding to the one or more supplementary cycles is a test pressure.

18. A system for determining a predictive life of a pressure containing component, comprising:
a blowout preventer (BOP) having one or more cavities with respective associated components, wherein a cavity of the one or more cavities are exposed to a pressure responsive to activation of at least a portion of the BOP;
a sensor associated with the BOP;
a control system configured to determine, based at least in part on sensor information corresponding to one or more cycles for the BOP, a predictive life for at least one of the respective associated components, the predictive life being based, at least in part, on a fracture mechanics model processing the sensor information and historical information to determine a difference between a current state of the at least one respective associated component and a failure state.

19. The system of claim 18, further comprising:
a communication system to transmit, in real or near-real time, the sensor information.

20. The system of claim 18, wherein the sensor is positioned proximate a lowest cavity of the one or more cavities.
